(19) United States
(12) Patent Application Publication
(10) Pub. No.: US 2009/0068904 A1
(43) Pub. Date: Mar. 12, 2009

(54) Mold case attached with retainer

(75) Inventors: Takeshi Sato, Tokyo (JP); Taku Kawano, Tokyo (JP)

Correspondence Address: WENDEROTH, LIND & PONACK, L.L.P., 2033 K STREET N. W., SUITE 800, WASHINGTON, DC, 20006-1021, US

(73) Assignee: Honda Tsushin Kogyo Co., Ltd

(21) Appl. No.: 12/230,758

(22) Filed: Sep. 4, 2008

(30) Foreign Application Priority Data
Sep. 6, 2007 (JP) 2007-231337

(51) Int. Cl. H01R 13/506

(52) U.S. Cl. 439/892

(57) ABSTRACT

To prevent from being destructed by an external force in a retainer attached mold case of a plug connector including an insulating member having aligned containing holes containing contacts, a shield case surrounding around the insulating member, a substantially cylindrical mold case incorporating these therein and having slits for grounding at two side walls thereof and an elastic daw with a lock portion and a lock release portion at an upper face, and a retainer for dosing a rear end opening of the mold case excluding a cable inserting portion, a locking projection is projected to a rear side from a rear end portion of the elastic daw, and a float preventing piece for preventing the elastic daw from being floated up by engaging with the locking projection is projected from a front end portion of the retainer.

### BACKGROUND OF THE INVENTION

1. Field of the Invention

The present invention relates to a mold case attached with a retainer of a plug connector in a wire harness or the like of an automobile.

2. Prior art

In a prior art, as shown in FIG. 10, a plug connector “A” attached with a cable of a wire harness or the like is constituted by a rectangular slender mold case 100, a retainer 105 mounted to a rear portion of the mold case, and a cable 106 in which a plurality of pieces of core wires are connected to a female contact of an insulating member 107 fixedly attached to inside of the mold case and led out to a rear side of the mold case. The mold case 100 is provided with a slit 101 at a side wall thereof and a portion of a shield case 103 surrounding the insulating member 107 at inside thereof is exposed to outside. Further, an upper portion of the mold case is provided with an elastic claw 102 for connection locking, a projection 102a for locking, and a press portion 102b for releasing.

A fitting counter of the plug connector “A” coaxial therewith is an adaptor connector “B” soldered onto a printed board 108, and an insulating member 109 fixed integrally with a male contact soldered to the printed board 108 is surrounded by a shield case 110. At an inner space of the insulating member 109, a ground plate 111 to be brought into electric contact with the shield case 103 on a side of the plug connector “A” is attached to a side wall thereof, a lower portion thereof is provided with a guide groove 112, and an upper portion thereof is provided with a lock portion 113 by which the locking projection 102a of the elastic claw 102 is locked.

The cable attached plug connector “A” constituted as described above is inserted from an opening portion of the insulating member 109 of the adaptor connector “B”, the locking projection 102a of the elastic claw 102 is engaged with the lock portion 113 and is inserted to a locking state to be connected, which is known as a publicly-known example (refer to JP-A-200593149).

However, according to the cable attached plug connector “A” of the prior art, as shown in FIGS. 11B and 11C, a projected portion 102c is provided at a side face of the elastic claw 102 for preventing the elastic claw 102 from being floated up, a side face thereof is provided with a wall 105a for locking, and therefore, the elastic claw 102 can be prevented from being floated up. However, the releasing press portion 102b on a rear side of the elastic daw 102 is not prevented from being turned up at all. Therefore, the elastic daw 102 cannot be prevented from being floated up completely.

Further, although in order to ground the mold case 100 at the side face, the slit 101 is provided and the shield case 103 and the ground plate 111 are made to be brought into contact with each other, as shown in FIGS. 12A and 12B, by notching to form the slit 101, there is a case of destructing a lower portion 104 of the mold case 100 when in a case in which the cable attached plug connector “A” is caught thereby and cannot be smoothly inserted in inserting the cable attached plug connector “A” from the opening portion of the insulating member 109, the cable attached plug connector “A” is forcibly screwed in. Further, also in the retainer 105, there poses a problem that when a rapid force is exerted to an opening edge portion thereof by the cable 106, the retainer 105 is opened and the retainer per se is destructed.

### SUMMARY OF THE INVENTION

Hence, in view of the above-described problem in the prior art, it is an object of the invention to provide a retainer attached mold case preventing an elastic claw from being destructed in fitting the elastic claw by preventing the elastic claw from being floated up and preventing a retainer from being opened and destructed.

A mold case for a plug connector according to the invention is a retainer attached mold case of a plug connector including an insulating member having aligned containing holes containing contacts, a shield case surrounding around the insulating member excluding a front face thereof, a mold case substantially constituting a cylindrical case incorporating the insulating member and the shield case at an inner space portion in which two side walls thereof are formed with slits for grounding opened to communicate with a front end opening and an upper face thereof includes an elastic claw having a lock portion extended to a rear side by being turned back from a front end portion and a lock release portion, and a retainer for dosing a rear end opening of the mold case by excluding a cable inserting portion; wherein a locking projection is projected to a rear side from a rear end portion of the elastic claw, and a float preventing piece for preventing the elastic claw from being floated up by being engaged with the locking projection is projected from a front end portion of the retainer.

It is preferable that inner wall faces of upper portions of two side walls of the elastic claw at the mold case are formed with engaging grooves extended in a front and rear direction, and engaging portions fated to the engaging grooves are formed to project horizontally at two side walls of the float preventing piece.

It is preferable that engaging portions projected to inner sides for engaging with the insulating member are respectively provided on upper and lower sides of an opening edge portion of a front end of the mold case, a front end portion of the insulating member is formed with guide grooves respectively engaged with the engaging portions, and an upper portion and a lower portion of the mold case divided by the slit is prevented from being opened in an up and down direction.

According to the retainer attached mold case of the invention, the locking projection is projected to the rear side from the rear end portion of the elastic claw, the float preventing piece for preventing the elastic claw from being floated up by engaging with the locking projection is projected from the front end portion of the retainer, and therefore, the elastic claw is not floated up and is not destructed even when forcibly screwed in being fitted.

Further, the engaging grooves extended in the front and rear direction are formed at the inner wall faces of the upper portions of the two side walls of the elastic claw of the mold case, the engaging portions fitted to the engaging grooves are formed to project horizontally at the two side faces of the float preventing piece, and therefore, even when a rapid force by the cable is exerted to the opening edge portion, the retainer per se is not destructed by opening the retainer.

Further, the upper and lower sides of the front end opening edge portion of the mold case are respectively provided with the engaging portions projected to the inner sides for engaging with the insulating member, the guide grooves for respectively engaging the engaging portions are formed at the front end portion of the insulating member, and therefore, a drawback of opening the front portion of the mold case in the up and down direction by the slit is resolved.

### BRIEF DESCRIPTION OF THE DRAWINGS

FIG. 1 is a disassembled perspective view showing a plug connector having a mold case attached with a retainer according to an embodiment of the invention;

FIG. 2A is a perspective view showing the mold case for the plug connector;

FIG. 2B is a vertical sectional view showing a state of engaging the mold case and the retainer;

FIG. 3A is a rear view showing the mold case;

FIG. 3B is a front view showing the retainer;

FIGS. 4A and 4B are a plane view and a front view showing a behavior of fitting the mold case and the retainer;

FIGS. 5A, 5B and 5C are a plane view, a rear view, and a side view of the retainer attached mold case;

FIG. 6 is a perspective view showing an insulating member of the plug connector;

FIGS. 7A and 7B are a front view and a side view of the plug connector;

FIG. 8 is a perspective view showing a behavior of fitting the plug connector to an adaptor connector;

FIG. 9 is a perspective view showing a state of fitting the plug connector to the adaptor connector;

FIG. 10 is a perspective view showing a behavior of fitting a plug connector of a prior art to an adaptor connector;

FIGS. 11A, 11B, 11C, and 11D are a plane view, a partial front view, a partial rear view, and a partial side view of the plug connector of the prior art; and

FIGS. 12A and 12B are a front view and a side view of the plug connector of the prior art

### DETAILED DESCRIPTION OF THE PREFERRED EMBODIMENTS

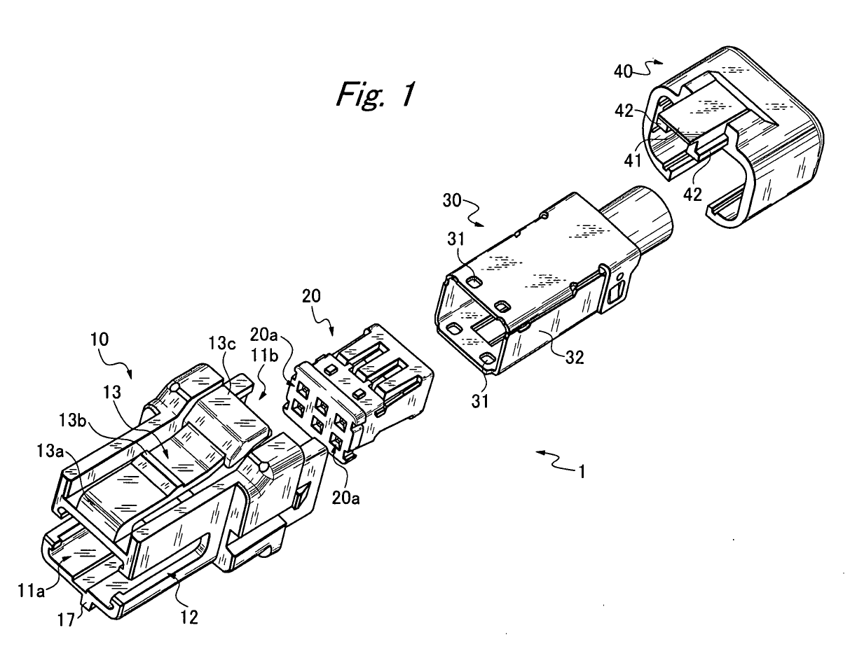

As shown in FIG. 1, a plug connector 1 having a mold case 10 attached with a retainer according to an embodiment of the invention is constituted by an insulating member 20 aligned with containing holes 20a containing female contacts (not illustrated), a shield case 30 surrounding around the insulating member 20 excluding a front face thereof, the mold case 10 substantially in a cylindrical shape incorporating these at an inner space portion, and the retainer 40 dosing a rear end opening 11b of the mold case 10 excluding a cable inserting portion.

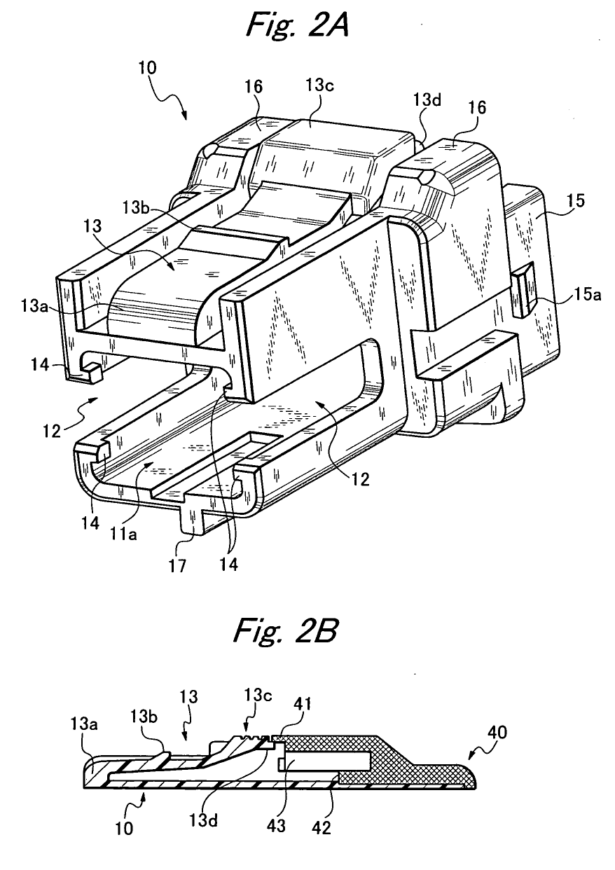

According to the mold case 10, as shown in FIGS. 2A and 2B, two side walls thereof are formed with slits 12, 12 for grounding opened to communicate with a front end openings 11a, and an upper face thereof formed in a recess shape is provided with an elastic claw 13 extended to a rear side by being turned back from a front end portion 13a. Four portions of an edge portion of the opening 11a are respectively formed with engaging portions 14 constituting projections for engaging. Further, a side face of a rear end portion is projected with a locking projection 15a for locking the retainer 40 when the retainer 40 is dosed. A lower face on a front-end side is projected with a guide projection 17 for guiding in fitting to the adaptor connector to be directed to a lower side.

The elastic claw 13 includes a projection 13d extended to a rear side of a rear end portion from the front end portion 13a and projected to a rear side, a lock release portion 13c formed at an upper face of the rear end portion, and a lock portion 13b projected from an upper face of a middle portion. The elastic claw 13 is formed to be able to move in an up and down direction by constituting a base point by the front end portion 13a by pressing down the lock release portion 13c. Further, the elastic claw 13 is prevented from being floated up by engaging a float preventing piece 41 formed at a front end portion of the retainer 40 with the projection 13d.

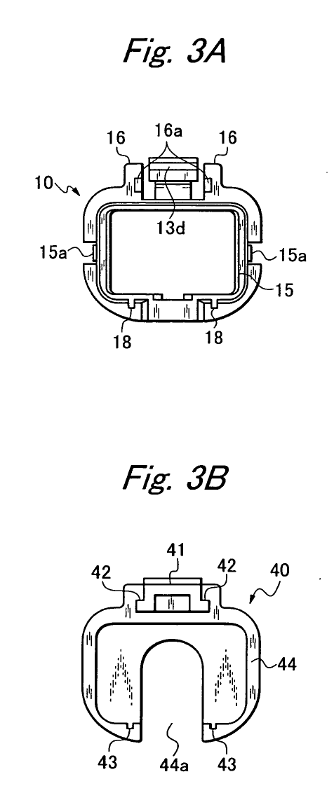

As shown in FIG. 3A, inner wall faces of two side wall upper portions 16, 16 of the lock portion 13b of the elastic claw 13 arranged at a center of the upper face of the mold case 10 are formed with engaging grooves 16a, 16a to which engaging portions of the retainer 40 mentioned later are fitted. Further, a lower face of the rear end portion is formed with projected portions 18, 18 fitted to recess grooves formed at an inner side bottom face of the front-end portion of the retainer 40.

On the other hand, as shown in FIG. 3B, the retainer 40 includes a float preventing piece 41 extended to a front side from a center of the upper portion, and two side faces of the float preventing piece 41 are provided with engaging portions 42, 42 fitted to the engaging grooves 16a, 16a of the mold case 10 to project horizontally. Further, the inner side bottom face of the front-end portion is formed with recess grooves 43, 43 to which the projected portions 18, 18 of the mold case 10 are fitted. A front end side of the retainer 40 is opened to be able to fit a rear end portion of the mold case 10, and a rear end side thereof is dosed by a rear wall 44 formed with a through hole 44a for inserting a cable.

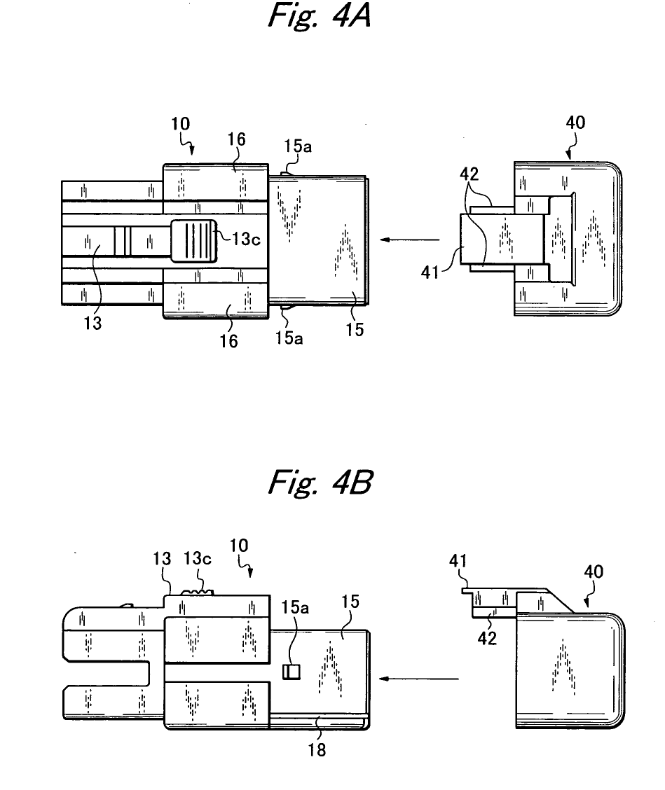

As shown in FIGS. 4A and 4B, when the retainer 40 is fitted to the rear end portion of the mold case 10 to dose the rear end opening 11b, the engaging portions 42, 42 at the two side faces of the float preventing piece 41 of the retainer 40 are fitted to the engaging grooves 16a, 16a of the inner wall faces of the two side wall upper portions 16, 16 of the mold case 10. Further, at the same time, the projected portions 18, 18 of the mold case 10 are fitted to the recess grooves 43, 43 formed at the inner side bottom face of the front end portion of the retainer 40.

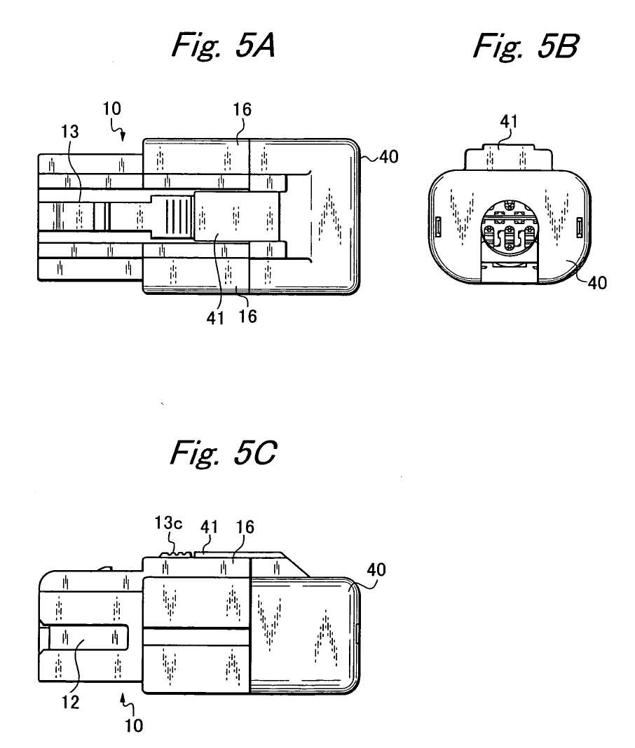

As shown in FIGS. 5A, 5B, and 5C, when the mold case 10 and the retainer 40 are fitted, the engaging portions 42, 42 of the retainer 40 and the engaging grooves 16a, 16a are fitted, at the same time, the projected portions 18, 18 of the mold case 10 and the recess grooves 43, 43 of the retainer 40 are fitted. That is, the both members are fitted on upper and lower sides thereof. The engagement of the retainer 40 with the mold case 10 becomes solid, and even when a rapid force is exerted to an edge portion of the through hole 44a of the rear wall 44 by a cable inserting through the through hole 44a, the retainer is not destructed by opening the retainer 40.

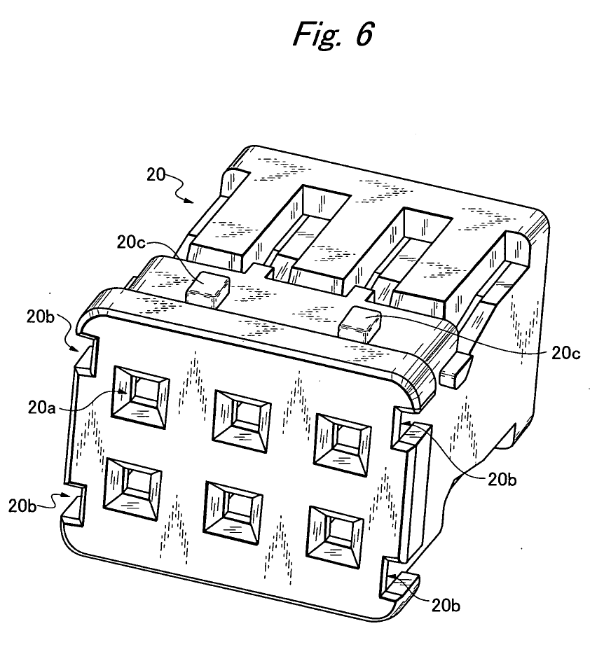

As shown in FIG. 6, the insulating member 20 is a mold member of a quadrangular shape and a front face thereof is opened with the plurality of containing holes 20a. Core wires of the cable are respectively electrically connected to female contacts contained in the containing holes 20a. A front end side portion of the insulating member 20 is formed with guide grooves 20b of respectively engaging the engaging portions 14 of the mold case 10 at four portions, such that an upper portion and a lower portion of the mold case 10 divided by the slit 12 is not opened in an up and down direction. Further, an upper face and a lower face of the front-end side are provided with engaging projections 20c for engaging with the shield case 30 at respective two portions thereof.

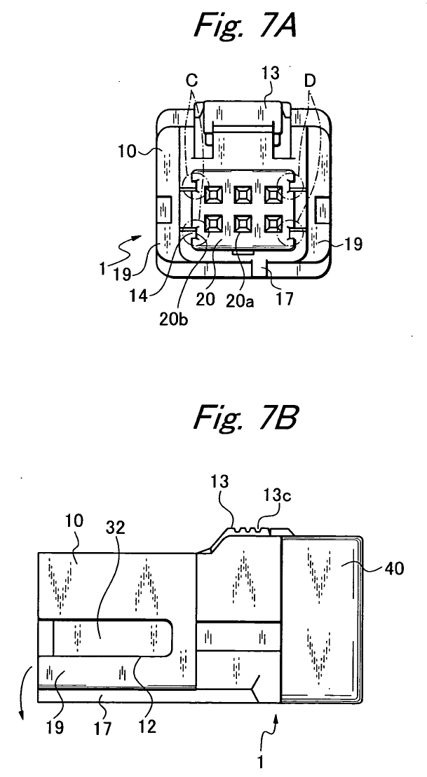

The shield case 30 is formed by a shape of a square cylinder, upper and lower faces of the front end side are respectively formed with engaging holes 31 at positions in correspondence with the engaging projections 20c of the insulating member 20, and when the shield case 30 is covered to the insulating member 20, the engaging projections 20c are engaged with the engaging holes 31 to bring about a state of not being drawn in a front and rear direction. When the assembly is mounted to the mold case 10, as shown in FIG. 7A, the engaging portions 14 at four portions of the front end portion of the mold case 10 are fitted to the guide grooves 20b at four portions of the front end portion of the insulating member 20 respectively substantially without gaps therebetween. As a result thereof, as is seen at portions C and D in the drawing, the integral insulating member 20 made of a synthetic resin is restricted from being moved in the up and down direction and at the front portion of the mold case 10, opening of the lower portion 19 by forming the slit 12 constituting the notch is prevented.

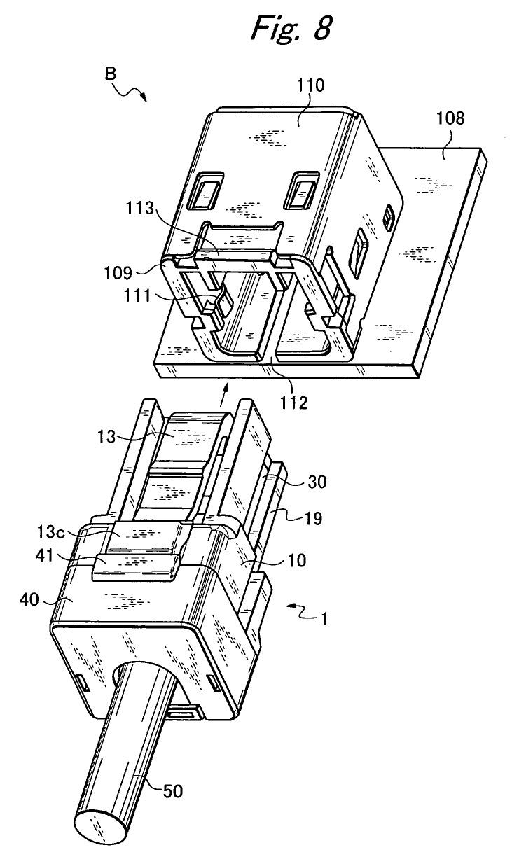

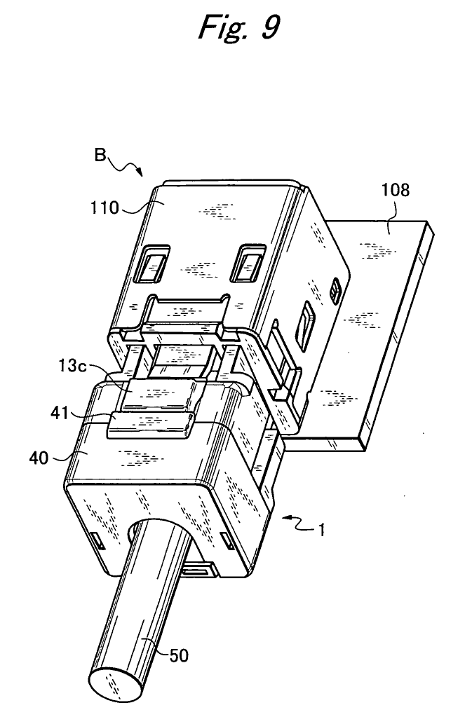

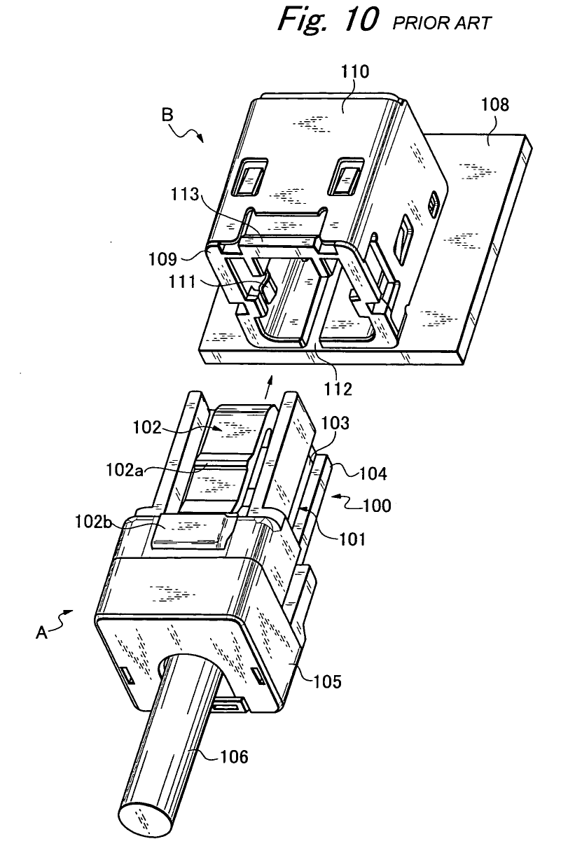

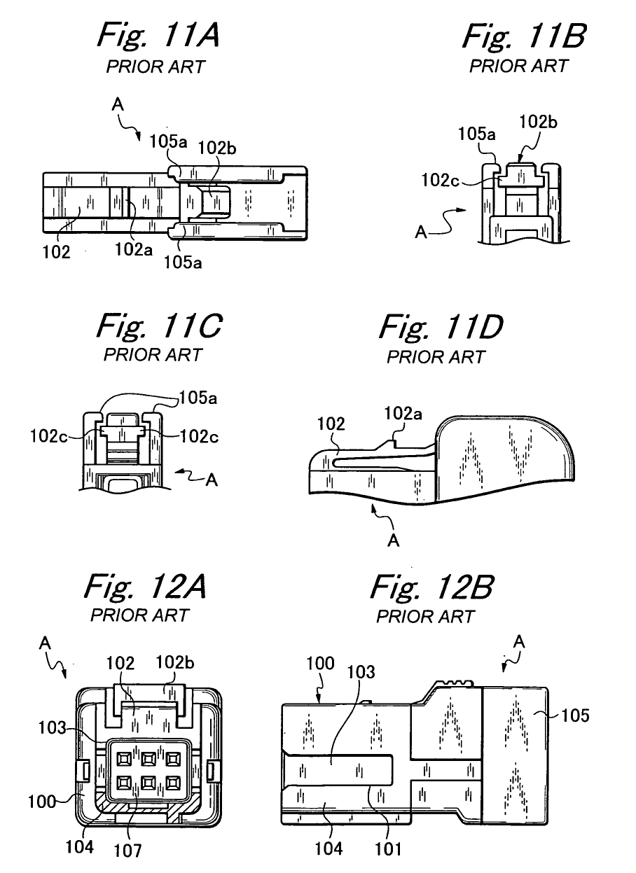

As shown in FIG. 8 and FIG. 9, the retainer attached mold case 10 constituted as described above is assembled as a cable attached plug connector connected with a cable 50 and fitted to the adaptor connector “B” on the printed board 108 to be electrically connected therewith. When fitted, the lock portion 13b of the elastic claw 13 of the mold case 10 is locked by the lock portion 113 of the adaptor connector “B”. When the lock release portion 13c is pressed to a lower side, the locking state is released, and the plug connector 1 is released from the adaptor connector “B”.

1. A retainer attached mold case of a plug connector comprising an insulating member having aligned containing holes containing contacts, a shield case surrounding around the insulating member excluding a front face thereof, a mold case substantially constituting a cylindrical case incorporating the insulating member and the shield case at an inner space portion in which two side walls thereof are formed with slits for grounding opened to communicate with a front end opening and an upper face thereof includes an elastic claw having a lock portion extended to a rear side by being turned back from a front end portion and a lock release portion, and a retainer for closing a rear end opening of the mold case by excluding a cable inserting portion;
wherein a locking projection is projected to a rear side from a rear end portion of the elastic claw, and a float-preventing piece for preventing the elastic claw from being floated up by being engaged with the locking projection is projected from a front-end portion of the retainer.

2. The retainer attached mold case according to claim 1, wherein inner wall faces of upper portions of two side walls of the elastic claw at the mold case are formed with engaging grooves extended in a front and rear direction, and engaging portions fitted to the engaging grooves are formed to project horizontally at two side walls of the float preventing piece.

3. The retainer attached mold case according to claim 1, wherein engaging portions projected to inner sides for engaging with the insulating member are respectively provided on upper and lower sides of the opening edge portion of the mold case, a front end portion of the insulating member is formed with guide grooves respectively engaged with the engaging portions, and an upper portion and a lower portion of the mold case divided by the slit is prevented from being opened in an up and down direction.

4. The retainer attached mold case according to claim 2, wherein engaging portions projected to inner sides for engaging with the insulating member are respectively provided on upper and lower sides of the opening edge portion of the mold case, a front end portion of the insulating member is formed with guide grooves respectively engaged with the engaging portions, and an upper portion and a lower portion of the mold case divided by the slit is prevented from being opened in an up and down direction.
